(19) United States
(12) Patent Application Publication
(10) Pub. No.: US 2001/0023438 A1
(43) Pub. Date: Sep. 20, 2001

(54) Method, apparatus, and recording medium for controlling image data transfer

(76) Inventor: Hironobu Ishida, Kaisei-machi (JP)

Correspondence Address: BIRCH STEWART KOLASCH & BIRCH, PO BOX 747, FALLS CHURCH, VA, 22040-0747, US

(21) Appl. No.: 09/760,843

(22) Filed: Jan. 17, 2001

(30) Foreign Application Priority Data
Jan. 17, 2000 (JP) 2000-007271
Dec. 28, 2000 (JP) 2000-399714

(51) Int. Cl. G06F 15/16; G06F 15/173

(52) U.S. Cl. 709/224; 709/203

(57) ABSTRACT

When a plurality of image data sets such as thumbnail images are transferred, stress of a user waiting for the transfer can be reduced. When a client requests a URL for displaying thumbnail images from a server, the server starts up a CGI program and sends data K for measuring a response time to the client. The client replies at the time of receiving the data, and the server measures the response time as a transfer rate on a network. Based on a permitted transfer time set in advance and the response time, the number of the image data sets is determined and an html file for displaying images whose number has been determined is transferred to the client. The client then requests transfer of the image data sets that have been determined from the server, and the server transfers the image data sets to the client. In this manner, the client can display the thumbnail images.

### BACKGROUND OF THE INVENTION

1. Field of the Invention

The present invention relates to a method and an apparatus for controlling image data transfer from a server in response to a request of a client. The present invention also relates to a computer-readable recording medium storing a program to cause a computer to execute the method of controlling image data transfer.

2. Description of the Related Art

Digital photographic service systems for carrying out various kinds of digital photographic services related to photographs, such as storing photographic images obtained by users in image servers after digitization thereof, providing the images to the users by recording the images in CD-Rs, and receiving orders of additional prints, have been known. As one form of such digital photographic service systems, a network photographic service system has also been proposed. In the network photographic service system, digital images of users are stored (registered) in a system of a service provider and printing orders or the like are received via a network such as the Internet.

In such a network photographic service system, a server computer comprising a printer, a scanner, and a large-capacity disc (hereinafter called an image server) is installed in a wholesale laboratory for providing the digital photographic services to the users. Photographic images obtained by the users are stored in the image server as image data and various kinds of services such as receiving an order of an additional print, attaching an image to an e-mail message, and download of the image data are provided to the users by enabling the users to access the image server via a network. In such a service, a laboratory generates and stores reduced image data for generating thumbnail images in order to lay out reduced user images for display. A user accesses the image server of the laboratory by using application software such as a Web browser installed in his/her personal computer and browses the thumbnail images. The user selects an image to be printed from the thumbnail images and generates order information regarding the selected image. The user then transfers the information to the laboratory. In the laboratory, photographic processing such as trimming and generation of an additional print, a postcard, an album, and a composite image is carried out on image data based on the order information from the user. The processed image data are then transferred to the user or an e-mail message notifying completion of the processing is sent to the user, for example.

In order to browse the thumbnail images stored in the laboratory, the user as a client requests, from the image server, an html file for displaying the thumbnail images by using the Web browser and the image server transfers the requested html file and the reduced image data necessary for displaying the thumbnail images to the personal computer of the user. In this manner, the thumbnail images are displayed on the personal computer of the user based on the html file.

More specifically, in the case where transfer of four thumbnail images is requested, the client which is the user requests the html file from the server in order to display the images, and the server transfers the file to the client, as shown in FIG. 4. The client receives the html file and requests transfer of image data sets 1 to 4 described in the html file from the server. The server receives the request and transfers the image data sets to the client. The client receives the image data sets and generates the thumbnail images based on the html file.

As has been described above, in order to display the thumbnail images, transfer of the image data sets for the plurality of images from the server to the personal computer of the user is necessary. Therefore, the user has to wait for a while until all the images are displayed. In the case where the network is busy, await for display of the thumbnail images becomes longer, which is stressful to the user. This problem occurs not only in the case of the network photographic service system but also in the case of browsing a Web site having a plurality of images therein on the Internet.

### SUMMARY OF THE INVENTION

The present invention has been conceived based on consideration of the above problem. An object of the present invention is therefore to provide an image-data transfer control method and an image-data transfer control apparatus for reducing stress caused by waiting for transfer of image data, and to provide a computer-readable recording medium storing a program to cause a computer to execute the image-data transfer control method.

An image-data transfer control method of the present invention is a method of controlling image data transfer between a server storing image data and a client connected to the server via a network and receiving the image data by accessing the server. The image-data transfer control method comprises the steps of:

measuring a transfer rate of the network at the time the client requests transfer of image data sets from the server; and

determining the number of the image data sets to be sent to the client in response to the transfer request, based on the transfer rate and a permitted transfer time determined in advance.

The “transfer rate” refers to an amount of data which can be transferred per a unit of time on the network at the time the client requests transfer of the image data sets from the server.

Measurement of the “transfer rate of the network” is carried out by setting the server to transfer the image data sets by starting a CGI (Common Gateway Interface) program having processing to measure the transfer rate in response to the client's transfer request, for example. A command having a certain amount of data for causing a reply to be sent after reception of data may be transferred from the client to the server or from the server to the client so that a response time from transmission of the command to reception of the reply can be measured, for example. By dividing the amount of the data by the response time, the transfer rate of the network can be measured. If the client has measured the transfer rate, a result of the measurement is transferred to the server.

When data are transferred on a network, a delay time generally occurs between transmission of the data by a sender and reception of the data by a recipient. When the amount of the data of the command is small at the time of measuring the transfer rate, a ratio of the delay time to the measured response time increases. Therefore, by increasing the amount of the data used in execution of the command, the ratio of the delay time decreases. In this manner, the transfer rate can be measured accurately. Furthermore, by measuring transfer times by executing a command having a small amount of data and a command having a large amount of data and then by dividing a difference between the data amounts by a difference between the transfer times, the transfer rate excluding the effect of the delay time can be found, which is more preferable.

The “permitted transmission time determined in advance” is a time that does not cause a user receiving the image data sets to become stressful until completion of transfer of the image data sets in one session, that is, in the processing from the transfer request to the transfer completion of the image data sets.

“Determining the number of the image data sets based on the transfer rate and the permitted transfer time determined in advance” refers to determining the time necessary for completion of transfer of the determined number of image data sets in such a manner that the time becomes close to the permitted transfer time, based on consideration of the transfer rate. Therefore, the transfer time of the determined number of image data sets to the client can be within the permitted transfer time or exceed the permitted time.

In the data-transfer control method of the present invention, it is preferable for the determined number of the image data sets to be transferred from the server to the client.

In this case, it is preferable for the determined number of the image data sets to be transferred from the server to the client, based on priority of the image data sets whose transfer is requested.

The “priority” can be determined based on a file size, a size of an image represented by each of the image data sets, a compression ratio of each of the image data sets, the date of generation of each of the image data sets, the date of photographing the image, or the date of last access, for example. In this manner, the image data sets can be transferred in order of file size (descending order or ascending order), in order of image size (descending order or ascending order), or in chronological order of image data generation, photographing, or last access (descending order or ascending order), for example. Alternatively, the priority of image data transfer may be determined based on information representing the priority added to each of the image data sets, such as a priority number.

For the remaining image data sets which are requested but not transferred from the server to the client due to a network condition, it is preferable for low volume data sets of the remaining image data sets to be transferred from the server to the client.

The “low volume data sets” refer to data sets having smaller amounts of data than the image data sets. More specifically, in the case where the image data sets comprise color image data, the low volume data sets refer to monochrome image data sets representing the same images, low-resolution image data sets representing images having a lower resolution than the images represented by the image data sets, or image data sets having fewer colors. Alternatively, information accompanying the image data sets can be used as the low volume data sets. As the “accompanying information”, information described in a header of each of the image data sets, such as a title of the image represented by the image data set, the date of photographing, the name of a photographer, a file size, an image size, a compression ratio, the date of image data generation, the date of last access, or a comment on the image, can be used.

In the case where transfer of the image data sets corresponding to the low volume data sets is requested, it is preferable for the image data sets whose transfer is currently requested to be transferred from the server to the client.

In the case where the transfer rate of the network is substantially low, even transfer of one set of image data is time-consuming in some cases. In such a case, the number of the image data sets to be transferred to the client can be 0. If the number of the image data sets to be transferred is 0, it is preferable for a message such as “request transfer later since the network is busy” to be transferred to the client.

Furthermore, information representing the measured transfer rate may be transferred to the client. More specifically, the information representing the transfer rate may be transferred as a number representing the transfer rate itself, or as characters corresponding to the transfer rate, such as “fast”, “normal”, or “slow”. Alternatively, a bar chart in accordance with the transfer rate or an icon showing a speed of transfer, such as “a rabbit” or “a turtle”, may be used as the information.

In the image-data transfer control method of the present invention, the image data sets may be thumbnail image data for displaying, on the client, thumbnail images comprising images represented by the image data sets.

An image-data transfer control apparatus of the present invention is an apparatus for controlling image data transfer between a server storing image data and a client connected to the server via a network and receiving the image data by accessing the server. The image-data transfer control apparatus comprises:

means for measuring a transfer rate of the network at the time the client requests transfer of image data sets from the server; and

means for determining the number of the image data sets to be transferred to the client in response to the transfer request, based on the transfer rate and a permitted transfer time determined in advance.

It is preferable for the image-data transfer control apparatus of the present invention to further comprise means for transferring the determined number of the image data sets from the server to the client.

In this case, it is preferable for the transfer means to transfer the determined number of the image data sets from the server to the client based on priority of the image data sets whose transfer is requested.

It is also preferable for the transfer means to transfer, from the server to the client, low volume data sets of the remaining image data sets other than the image data sets whose transfer has been determined.

It is also preferable for the transfer means to transfer, from the server to the client, the image data sets corresponding to the low volume data sets when transfer of the image data sets corresponding to the low volume data sets is requested.

In the case where the number of the image data sets has been determined to be 0, it is preferable for the image-data transfer control apparatus of the present invention to further comprise means for sending a message to the client notifying that the number of the image data sets 0.

It is also preferable for the image-data transfer control apparatus of the present invention to further comprise means for transferring information representing the transfer rate to the client.

In the image-data transfer control apparatus of the present invention, the image data sets can be thumbnail image data for displaying, on the client, thumbnail images comprising images represented by the image data sets.

The image-data transfer control method of the present invention may be provided as a program recorded in a computer-readable recording medium to cause a computer to execute the image-data transfer control method.

According to the present invention, when the client requests transfer of the image data sets from the server, the transfer rate of the network is measured. Based on the measured transfer rate and the permitted transfer time, the number of the image data sets to be transferred is determined in such a manner that the time necessary for completion of the transfer of the image data sets becomes close to the permitted transfer time. Therefore, in one session when transfer of the image data sets is requested, the time necessary for completion of transfer of the image data sets becomes close to the permitted transfer time. In this manner, stress imposed on the user can be reduced.

Furthermore, by transferring the determined number of the image data sets based on the priority of the image data sets whose transfer is requested, the client can receive the image data sets having higher priority.

By transferring the low volume data sets of the remaining image data sets, the client understands what the image data sets which are not transferred are like, based on the low volume data sets.

In the case where transfer is requested for the low volume data sets, the image data sets corresponding to the low volume data sets are transferred so that the client can obtain the image data sets which are necessary but were not transferred at an earlier request.

Furthermore, in the case where the number of the image data sets that has been determined is 0, the message notifying the determination is sent to the client. Therefore, the user realizes from the message that the image data sets are not being transferred due to the network being busy.

Moreover, by transferring the information representing the transfer rate to the client, the client knows the transfer rate and easily recognizes a state of the network.

### BRIEF DESCRIPTION OF THE DRAWINGS

FIG. 1 is a block diagram showing a configuration of a data transfer system adopting an image-data transfer control apparatus as an embodiment of the present invention;

FIG. 2 is a diagram explaining operation of this embodiment;

FIG. 3 is a flow chart showing the operation of the embodiment; and

FIG. 4A and 4B show how transferred image data sets are shown;

FIG. 5 shows a state in which accompanying information of image data sets which are not transferred is displayed;

FIG. 6 shows a state in which image data sets whose transfer was requested are displayed;

FIG. 7A through 7D show how a transfer rate is displayed; and

FIG. 8 is a diagram explaining conventional transfer of image data.

### DESCRIPTION OF THE PREFEREED EMBODIMENT

Hereinafter, an embodiment of the present invention will be explained with reference to the accompanying drawings.

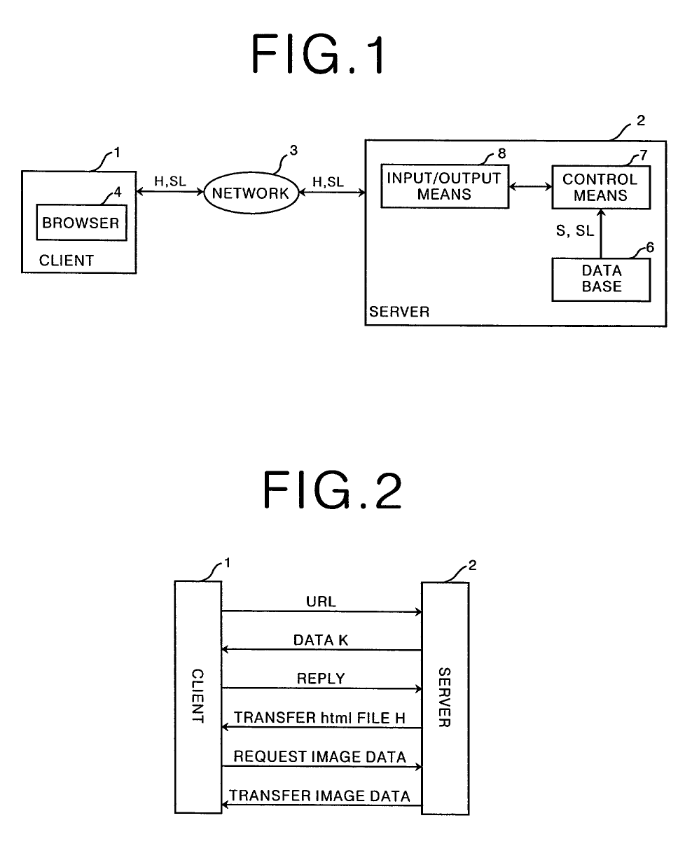

FIG. 1 is a block diagram showing a configuration of a data transfer system adopting an image-data transfer control apparatus according to the embodiment of the present invention. As shown in FIG. 1, the data transfer system in this embodiment comprises a client 1 which is a personal computer of a user and a server 2 installed in a laboratory serving as a Web server. The client 1 and the server 2 are connected via a network 3. A Web browser 4 installed in the client 1 causes the server 2 to carry out image data transfer.

The server 2 comprises a database 6 for storing high-resolution image data sets S representing images of the user and low-resolution image data sets SL generated by reducing the image data S, control means 7 for measuring a transfer rate of the network 3 by running a CGI program in response to a request made by the client 1 and for generating an html file H according to a measurement result, and input/output means 8 for transferring the html file H, the image data sets S and the low-resolution image data sets SL to the client 1 and for receiving data from the client 1. The control means 7 corresponds to means for measuring the transfer rate of the network and means for determining the number of the image data sets, while the input/output means 8 corresponds to means for transferring the image data sets from the server 2 to the client 1.

When requesting transfer of thumbnail images, the client 1 requests a URL of the CGI program for thumbnail-image display. The server 2 receives this request and starts up the CGI program. The CGI program describes processing for measuring the transfer rate of the network 3 at the start of the program. The CGI program also describes processing for determining, based on the transfer rate and a permitted transfer time set in advance, the number of the low-resolution image data sets SL to be transferred, and processing for generating and transferring to the client 1 the html file H for displaying the images in accordance with the number.

Operation of this embodiment will be explained next.

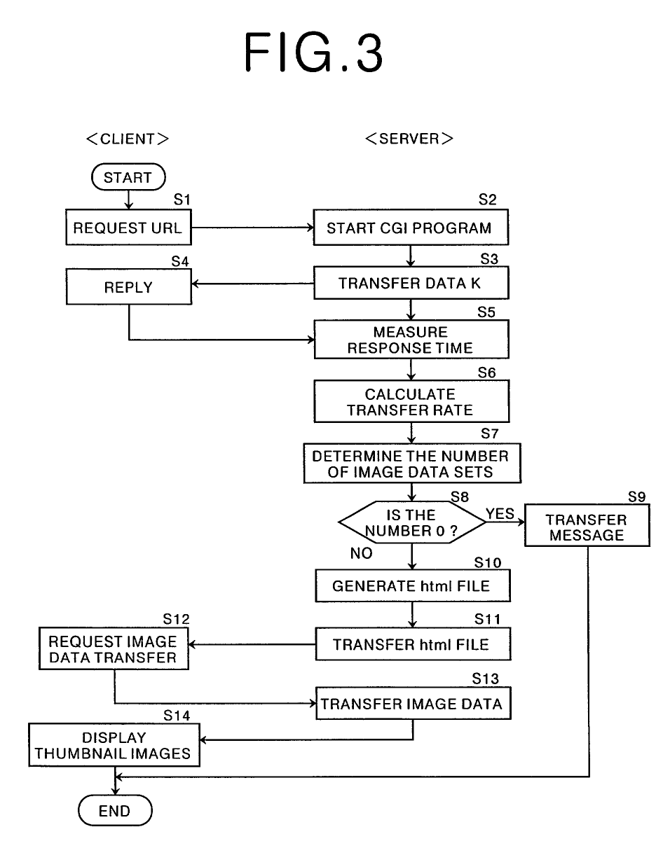

FIG. 2 is a diagram for explaining the operation and FIG. 3 is a flow chart showing the operation. The client 1 requests the URL of the CGI program for generating the thumbnail images of the user images from the server 2 (Step S1). The server 2 receives this request and starts up the CGI program for generating the thumbnail images (Step S2).

The transfer rate of the network 3 is measured when the CGI program is started.

The CGI program describes the following processing for measuring the transfer rate:

(1) The server 2 transmits data K having a predetermined amount of data to the client 1 for response-time measurement.

(2) The client 1 replies at the time of receiving the data K.

(3) The server 2 measures a response time T at the time of receiving the reply from the client 1.

(4) The transfer rate is calculated by dividing the amount of the data K by the response time T.

Therefore, when the transfer-rate measuring processing is executed, the server 2 transmits the data K to the client 1 (Step S3), and the client 1 replies upon receipt of the data K (Step S4). The server 2 measures the response time T from the transmission of the data K to the reply (Step S5). The transfer rate is calculated by dividing the amount of the data K by the response time T (Step S6).

After the transfer rate has been calculated in the above manner, the number of the image data sets SL to be transferred to the client 1 is determined, based on the permitted transfer time stored in a memory not shown in FIG. 1 and the transfer rate (Step S7). The permitted transfer time is set to such a degree as not to cause the user receiving the image data sets to feel stressed before completion of image data transfer. While the number of the image data sets SL to be transferred is changed variously, time necessary for completion of transfer of the image data sets SL is found by dividing total amount of the image data sets SL by the transfer rate. The number of the image data sets SL is determined so that time necessary for transferring the image data sets SL at once becomes close to the permitted transfer time. For example, assume that four sets of the image data SL are transferred if the network 3 is not busy. If the measured transfer rate is a quarter of the transfer rate of the case where the network 3 is not busy, the number of the image data sets SL to be transferred is 1. Therefore, in this embodiment, the number of the image data sets SL that has been determined is 1. If the measured transfer rate is one half of the transfer rate of the case of the network 3 being not busy, the number of the image data sets to be transferred is determined to be 2.

The image data sets SL to be transferred are determined based on priority of the image data sets SL whose transfer is currently requested. In this case, the priority can be determined based on a file size of each of the image data sets SL, a size of an image represented by each of the image data sets SL, a compression ratio of each of the image data sets SL, the date of generation of each of the image data sets SL, the date of photographing the image, or the date of last access, for example. In this manner, the image data sets SL can be transferred in order of file size (ascending or descending order), in order of image size (ascending or descending order), or in chronological order of image data set generation, photographing, or last access (descending or ascending order), for example. Alternatively, information representing the priority, such as a priority number, may be added to each of the image data sets SL in advance so that the priority can be determined based on the information. In this manner, the client can obtain the image data sets SL whose priority is higher, which will be explained later.

If the number of the image data sets SL has been determined to be 0, a result at Step S7 becomes affirmative and a message saying “request transfer later since the network is busy” is transferred to the client 1 (Step S8) to end the procedure. The input/output means 8 corresponds to means for transferring the message notifying the number of the image data sets being 0 to the client.

Meanwhile, when the number of the image data sets is determined in the above manner, the result at Step S8 becomes negative. The html file H for displaying the images represented by the image data sets SL to be transferred in this session is then generated (Step S10). The server 2 transfers the html file H to the client 1 (Step S11). The processing from Step S7 to Step S11 after the measurement of the transfer rate is described in the CGI program.

The client 1 requests transfer of the image data set SL from the server 2 based on the html file H (Step S12). The server 2 receives the request and transfers the image data set SL to the client 1 (Step S13). The client 1 displays the thumbnail image based on the html file H and the image data set SL (Step S14) to end the procedure.

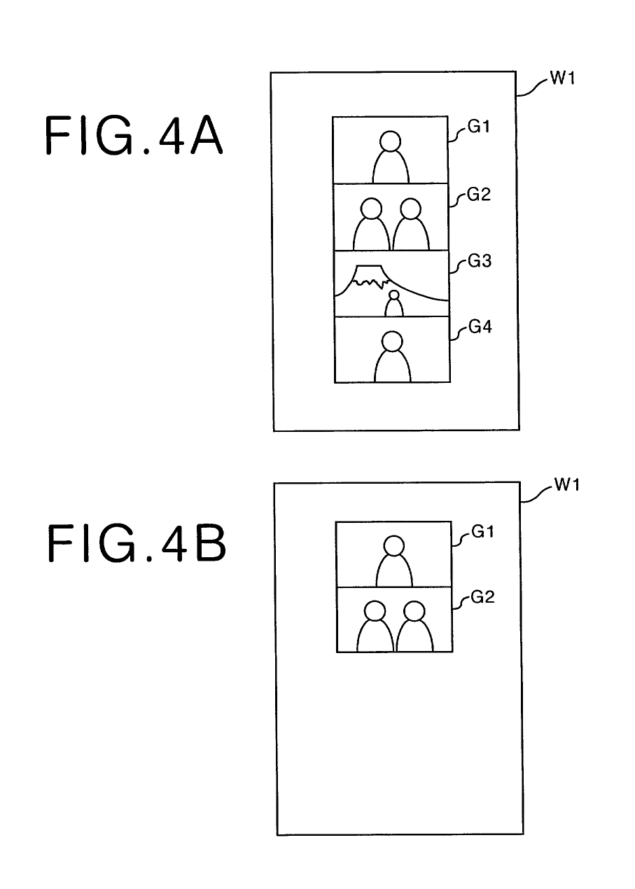

In the case where transfer of four sets of the image data SL is requested, four thumbnail images G1˜G4 are displayed in a predetermined window W1 on the client 1 in the case of the network 3 not being busy, as shown in FIG. 4A. In the case where the determined number of the image data sets SL is two, only the two thumbnail images G1 and G2 are displayed, as shown in FIG. 4B.

After display of the thumbnail image, the user confirms the thumbnail image and transfers order information describing the content of an order for printing the image represented by the data set SL to the server 2. The server 2 reads the corresponding high-resolution image data set S from the database 6 and prints the image data S.

As has been described above, in this embodiment, the number of the image data sets SL to be transferred is determined based on the transfer rate of the network 3. Therefore, the time necessary for completion of the transfer of the image data sets SL in one session becomes close to the permitted transfer time. In this manner, the user becomes less stressful when waiting for completion of the transfer.

In the above embodiment, the transfer rate of the network 3 is measured by executing the processing in the CGI program. However, when the client requests the transfer of the thumbnail images, a command requesting a reply may be transferred from the client 1 to the server 2 or from the server 2 to the client 1 to cause the server 2 or the client 1 to reply upon receiving the command so that time from the command transfer to the reply can be measured. In this manner, the transfer rate can be measured. When the client 1 measures the transfer rate, a result of the measurement is transferred to the server 2 and the number of the image data sets to be transferred is determined based on the result.

In the above embodiment, the browser 4 and the Web server are used as the client 1 and the server 2. However, any client-server program dealing with image data (such as FTP or an original protocol) may be used.

In the above embodiment, the number of the image data sets to be transferred is determined by the CGI program. However, a Java servelet or another server-side program can also be used.

In the above embodiment, the determined number of the image data sets SL are transferred to the client 1 at Step S13. However, for the image data sets SL other than the image data sets SL transferred to the client 1 (hereinafter called non-transfer image data sets), low volume data sets of the non-transfer image data sets may be transferred to the client 1. The low volume data sets refer to data sets having smaller amounts of data than the image data sets. More specifically, in the case where the image data sets comprise color image data, the low volume data sets refer to monochrome image data sets representing the same images, low-resolution image data sets representing images having a lower resolution than the images represented by the image data sets SL, or image data sets having fewer colors. Alternatively, information accompanying the image data sets SL can be used as the low volume data sets. As the “accompanying information”, information described in a header of each of the image data sets SL, such as a title of the image represented by each of the image data sets SL, the date of photographing, the name of a photographer, a file size, an image size, a compression ratio, the date of image data generation, the date of last access, and a comment on the image, can be used.

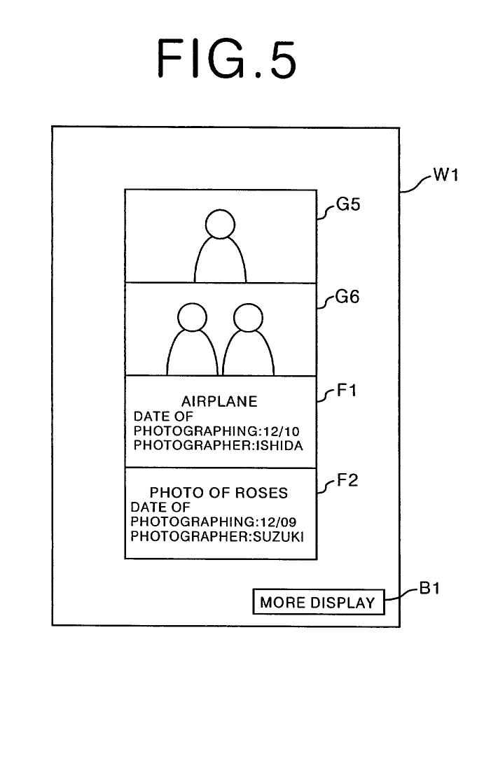

More specifically, in the case where transfer of four sets of the image data SL is requested and the number of the image data sets SL that has been determined is two, the determined two image data sets SL are transferred. Meanwhile, for the two image data sets SL that are not transferred, accompanying information items F1 and F2 thereof (a title of the image, the date of photographing, and the name of a photographer in this case) are transferred. The accompanying information items F1 and F2 are displayed on the client 1, together with two images G5 and G6 represented by the image data sets SL, as shown in FIG. 5. In the case where the accompanying information items of the non-transfer image data sets are transferred, the accompanying information items are added to a header of the html file H when the html file H is generated at Step S10 in FIG. 3. Meanwhile, in the case where the low volume data sets of the non-transfer image data sets are monochrome image data or the like, the html file H including information indicating the low volume data sets being the monochrome image data or the like is generated at Step S10, and the low volume data sets are transferred at Step S13, together with the image data sets SL whose transfer has been determined.

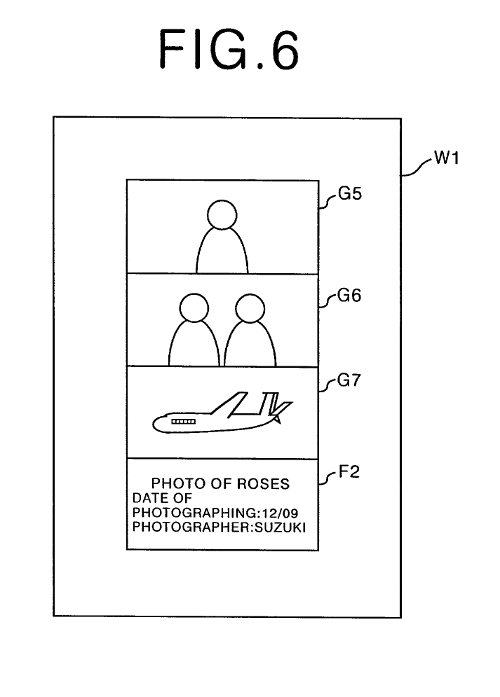

After the low volume data sets are displayed for the non-transfer image data sets, the image data sets SL corresponding to the low volume data sets may be transferred by clicking display of the low volume data sets. For example, when transfer is requested by clicking a portion “airplane” in FIG. 5, the corresponding image data sets SL representing the thumbnail image of the airplane is transferred and an image G7 represented by the image data set SL is displayed on the client 1, as shown in FIG. 6.

At this time, by requesting transfer of other sets of the non-transfer image data, the image data sets SL corresponding to all the low volume data sets can be transferred.

Furthermore, by clicking a “more display” button B1 shown in FIG. 5, all the non-transfer image data sets may be transferred.

Moreover, in the above embodiment, information representing the measured transfer rate may be transferred to the client and displayed thereon. More specifically, at Step S10 in FIG. 3, the html file H is generated so that the measured transfer rate can be displayed. By transferring the html file H at Step S11, the information indicating the transfer rate is transferred to the client 1 and displayed thereon. The input/output means 8 corresponds to means for transferring the information representing the transfer rate.

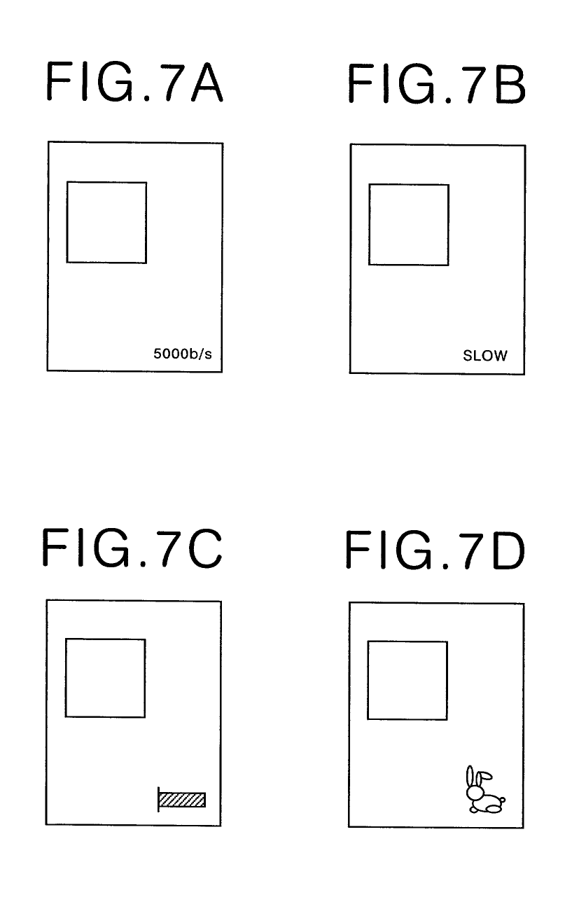

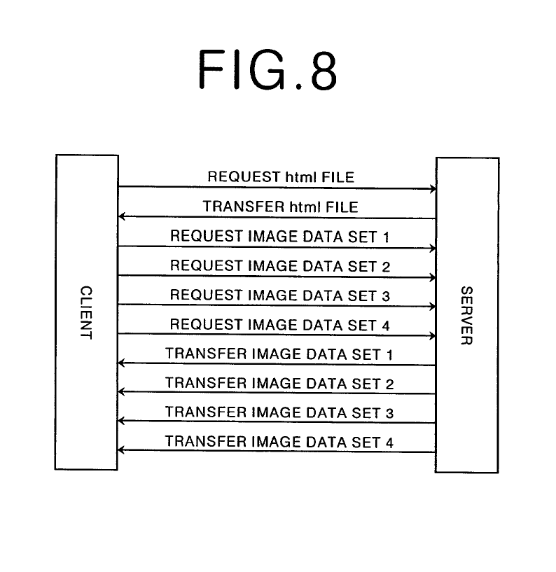

At this time, the client 1 may display the transfer rate itself as a number, as shown in FIG. 7A. Alternatively, the transfer rate may be displayed as characters corresponding to the transfer rate, such as “fast”, “normal”, or “slow”, or as a bar chart shown in FIG. 7C, for example. As shown in FIG. 7D, the transfer rate may also be displayed as an icon representing a speed of transfer, such as “a rabbit” or “a turtle”.

In the aspect of displaying the transfer rate as has been described above, if transfer of the non-transfer image data sets is requested, the transfer rate may be measured again to be displayed. Alternatively, the transfer rate that has been measured first may be displayed as it is, without new measurement.

In addition, all of the contents of Japanese Patent Application Nos. 2000-007271 and 2000-399714 are incorporated into this specification by reference.

What is claimed is:

1. A method of controlling image data transfer between a server storing image data and a client connected to the server via a network and receiving the image data by accessing the server, the image-data transfer control method comprising the steps of:
measuring a transfer rate of the network at the time the client requests transfer of image data sets from the server; and
determining the number of the image data sets to be sent to the client in response to the transfer request, based on the transfer rate and a permitted transfer time determined in advance.

2. An image-data transfer control method as defined in claim 1, further comprising the step of transferring the image data sets whose number has been determined from the server to the client.

3. An image-data transfer control method as defined in claim 2, wherein the step of transferring is the step of transferring the image data sets whose number has been determined from the server to the client, based on priority of the image data sets whose transfer is requested.

4. An image-data transfer control method as defined in claim 2, further comprising the step of transferring, from the server to the client, low volume data sets of a remaining portion of the requested image data sets excluding the image data sets whose transfer from the server to the client has been determined.

5. An image-data transfer control method as defined in claim 4, further comprising the step of transferring from the server to the client, in the case where transfer of the image data sets corresponding to the low volume data sets is requested, the image data sets corresponding to the low volume data sets whose transfer is requested.

6. An image-data transfer control method as defined in any on of claims 1 to 5, further comprising the step of transferring to the client a message notifying that the number of the image data sets to be transferred is 0 in the case where the number of the image data sets to be transferred has been determined to be 0.

7. An image-data transfer control method as defined in any one of claims 1 to 5, further comprising the step of transferring information representing the transfer rate to the client.

8. An image-data transfer control method as defined in any one of claims 1 to 5, wherein the image data sets are thumbnail image data for displaying, on the client, thumbnail images comprising images represented by the image data sets.

9. An apparatus for controlling image data transfer between a server storing image data and a client connected to the server via a network and receiving the image data by accessing the server, the image-data transfer control apparatus comprising:
means for measuring a transfer rate of the network at the time the client requests transfer of image data sets from the server; and
means for determining the number of the image data sets to be transferred to the client in response to the transfer request, based on the transfer rate and a permitted transfer time determined in advance.

10. An image-data transfer control apparatus as defined in claim 9, further comprising means for transferring the image data sets whose number has been determined from the server to the client.

11. An image-data transfer control apparatus as defined in claim 10, wherein the means for transferring transfers the image data sets whose number has been determined from the server to the client, based on priority of the image data sets whose transfer is requested.

12. An image-data transfer control apparatus as defined in claim 10, wherein the means for transferring transfers, from the server to the client, low volume data sets of a remaining portion of the requested image data sets excluding the image data sets whose transfer from the server to the client has been determined.

13. An image-data transfer control apparatus as defined in claim 12, wherein the means for transferring transfers, from the server to the client, the image data sets corresponding to the low volume data sets when transfer of the image data sets corresponding to the low volume data sets is requested.

14. An image-data transfer control apparatus as defined in any one of claims 9 to 13, further comprising means for sending a message to the client notifying that the number of the image data sets is 0 in the case where the number of the image data sets has been determined to be 0.

15. An image-data transfer control apparatus as defined in any one of claims 9 to 13, further comprising means for transferring information representing the transfer rate to the client.

16. An image-data transfer control apparatus as defined in any one of claims 9 to 13, wherein the image data sets are thumbnail image data for displaying, on the client, thumbnail images comprising images represented by the image data sets.

17. A computer-readable recording medium storing a program to cause a computer to execute a method of controlling image data transfer between a server storing image data and a client connected to the server via a network and receiving the image data by accessing the server, the program comprising the procedures of:
measuring a transfer rate of the network at the time the client requests transfer of image data sets from the server; and
determining the number of the image data sets to be sent to the client in response to the transfer request, based on the transfer rate and a permitted transfer time determined in advance.

18. A computer-readable recording medium as defined in claim 17, the program further comprising the procedure of transferring the image data sets whose number has been determined from the server to the client.

19. A computer-readable recording medium as defined in claim 18, wherein the procedure of transferring is the procedure of transferring the image data sets whose number has been determined from the server to the client, based on priority of the image data sets whose transfer is requested.

20. A computer-readable recording medium as defined in claim 18, the program further comprising the procedure of transferring, from the server to the client, low volume data sets of a remaining portion of the requested image data sets excluding the image data sets whose transfer from the server to the client has been determined.

21. A computer-readable recording medium as defined in claim 20, the program further comprising the procedure of transferring from the server to the client, in the case where transfer of the image data sets corresponding to the low volume data sets is requested, the image data sets corresponding to the low volume data sets whose transfer is requested.

22. A computer-readable recording medium as defined in any on of claims 17 to 21, the program further comprising the procedure of transferring to the client a message notifying that the number of the image data sets to be transferred is 0 in the case where the number of the image data sets to be transferred has been determined to be 0.

23. A computer-readable recording medium as defined in any one of claims 17 to 21, the program further comprising the procedure of transferring information representing the transfer rate to the client.

24. A computer-readable recording medium as defined in any one of claims 17 to 21, wherein the image data sets are thumbnail image data for displaying, on the client, thumbnail images comprising images represented by the image data sets.
